(19) United States
(12) Patent Application Publication
(10) Pub. No.: US 2017/0122779 A1
(43) Pub. Date: May 4, 2017

(54) ANGULAR POSITION SENSING DEVICE

(71) Applicant: Moog India Technology Centre Private Limited, Bangalore, Karnataka (IN)

(72) Inventors: Murali P. Krishna, Bangalore, Karnataka (IN); Ashoka Mayya, Bangalore, Karnataka (IN)

(73) Assignee: Moog India Technology Centre Privated Limited, Bangalore, Karnataka (IN)

(21) Appl. No.: 15/128,872

(22) PCT Filed: Aug. 18, 2014
(86) PCT No.: PCT/IN2014/000528

§ 371 Date: Sep. 23, 2016

(30) Foreign Application Priority Data
Mar. 28, 2014 (IN) 1672/CHE/2014

(51) Int. Cl. G01D 5/14; B64C 13/04

(52) U.S. Cl. CPC G01D 5/145; B64C 13/04

(57) ABSTRACT

An angular position sensing device (1) comprising Hall Effect sensors (4a, 4b) is disclosed. The sensors (4a, 4b) are mounted in front of at least one rotatable magnet (3). The output voltage of the sensors (4a, 4b) varies with changing rotational position of the magnet (3). The magnet (3) is suitably mounted and the magnetic surface has a varying surface profile such that in the event of rotation of the magnet (3), a uniformly varying air gap is formed between the sensors (4a, 4b) and the magnetic surface, thus creating a uniformly varying magnetic field. The voltage output of the sensors is linear and reflective of the angular position of magnet (3).

### FIELD OF THE INVENTION

The present invention in general, relates to an angular position sensing device which applies Hall Effect sensors for detection of angular position of the desired object. Particularly, the present invention relates to an angular position sensing device which can determine angular positions of the desired object with precision in a simple and economic way.

### TECHNICAL BACKGROUND OF THE INVENTION

It is traditionally known that there can be several precision and non-contact angular position sensors like resolvers, encoders, rotary variable differential transformer (hereinafter referred to as RVDT for the sake of brevity) and so on. These can be used for determining angular position of certain objects and pursuant to such detection, certain actuators are activated or deactivated.

For example, RVDTs are known to detect angular positions of flap and slat control lever of an air craft for activating and deactivating certain actuators along the wings, which can then extend/retract the flap and slats as may be required during lifting or landing of an aircraft.

The above is just an example and there can be several such applications as known to persons skilled in the art. The sensors as discussed before are known to be very costly. Further, angular position sensing devices known in the art are in general very costly due to application of these expensive sensors and also due to the cumbersome arrangement. However, it should be understood that in these types of applications redundancy and technical effectiveness have to be achieved and cannot be compromised with.

Having regard to the above considerations, application of Hall Effect sensors in angular position sensing devices had to be considered.

It is known that Hall Effect sensor varies its output voltage in response to a magnetic field. The voltage is proportional to the magnetic field which can be positive or negative. When a positive magnetic field is encountered, the output voltage goes above the null voltage (i.e. the voltage when there is no magnetic field). Once a negative magnetic field is encountered, the output voltage goes below the null voltage.

Furthermore, once a magnetic field is encountered no change in voltage output will occur till the operate point is reached. Once the operate point is reached, the sensor will change state. Further increase in magnetic field beyond the operate point will not cause any further change. Similarly, decrease in magnetic field will cause no change in output beyond the operate point. Once the release point is reached sensor output will return to original state (off). The purpose of differential between the operate and release point (hysteresis) is to eliminate false triggering caused due to minor variations in input.

In any event, the above aspects and other functional aspects of Hall Effect sensors are known to persons skilled in the art and are not elaborated further. Additionally, over the years Hall Effect sensors have been to known to find application in detection of position of permanent magnet in brushless DC electric motors, in internal combustion engine ignition timing, tachometers and anti-lock braking systems to name a few.

Application of Hall Effect sensors in angular position sensing devices is known. For example, U.S. Pat. No. 4,570,118 discloses a transducer with two arcuate pattern permanent magnets, with an air gap between them. A linear Hall Effect device is placed in the air gap. The magnets are rotated and the output of the Hall Effect device is monitored which varies according to the angular position of the member driving the transducer. This arrangement is expensive due to the complicated assembly of the rotating shaft and the magnets which are pivoted to the shaft.

U.S. Pat. No. 6,137,288 discloses a magnetic rotational position sensor comprising a loop pole piece and a magnet. This design uses a loop magnet with inner and outer pole surfaces, the magnetic field is guided to loop pole piece and passes through the Hall sensor in the same direction. The magnetic field is almost parallel to the sensor and hence the intensity of magnetic lines facing the sensor is very minimal and the sensor output is very small. Further, it requires a bit complicated electronics to process and amplify the sensor.

U.S. Pat. No. 6,703,829 discloses a semi annular magnet with diametric magnetization. The Hall sensor is positioned either at internal diameter of the magnet or at the outer diameter of the magnet, a “pole piece” or flux concentration enclosure is used to define the air gap. The construction is a bit complicated and the output from the sensors is not substantial to yield technically perfect results.

There has been a need in the art of designing angular position sensing devices, in a simple, cost effective and technically precise manner applying Hall Effect sensors, by ensuring maximum sensor output.

The present invention meets the above mentioned need and other associated needs by providing an angular position sensing device comprising Hall Effect sensors operatively connected to other elements in a simple and cost-effective yet technically perfect manner.

It would be clear from the following description and the appended claims that, the construction of the device is simple and cost-effective, but technical perfection has not been compromised with having regard to the functional importance of such angular position sensing devices.

It would be clear from the following description that rather, the present invention teaches enhancement of technical functioning of the device.

### OBJECTS OF THE INVENTION

It is the principal object of the present invention to provide an angular position sensing device which applies Hall sensors in association with other elements so that the device is not only simple and hence cost effective but also is technically precise due to maximum sensor output.

It is another object of the present invention to provide an angular position sensing device such that there is an improvement in functioning over known devices.

It is another object of the present invention to provide an angular position sensing device, which ensures substantially error free angular position detection of the desired object.

It is a further object of the present invention to provide a low cost non contact angular position sensor unit for angular position measurement with redundancy.

All through the specification including the claims, the words “magnetic surface”, “pole shoe”, “shaft”, “lever”, “actuators”, “Hall Effect sensors”, “housing”, “magnet”, are to be interpreted in the broadest sense of the respective terms and includes all similar items in the field known by other terms, as may be clear to persons skilled in the art.

Restriction or limitation, if any, referred to in the specification, is solely by way of example and for explaining the present invention.

### SUMMARY OF THE INVENTION

Accordingly, the present invention provides an angular position sensing device comprising Hall Effect sensors mounted in front of at least one rotatable magnet. The output voltage of the sensors varies with changing position of the magnet. The magnet is suitably mounted and the magnetic surface has a varying surface profile such that in the event of rotation of the magnet, an uniformly varying air gap is formed between the sensors and the magnetic surface, thus creating an uniformly varying magnetic field.

In accordance with preferred embodiments of the device of the present invention:

the profile is variable depending upon the angular position range to be detected;

the magnet is a ring magnet with said varying surface profile being located at the side facing the sensors and the ring magnet is rotatably mounted to a shaft operable by means of a lever or any other suitable mechanism;

the magnetic surface comprises a standard ring magnet attached to a pole shoe, the latter having a surface profile such that, in the event of rotation of the magnet and the pole shoe, an uniformly varying air gap between the pole shoe and the sensors is created;

the magnet and the pole shoes are rotatably attached to a shaft operable by means of a lever or any other suitable mechanism;

at least two sensors are mounted on a housing of the device using a mounting plate such that, the sensors are located in front of the pole shoe and its said surface profile is at the side facing the sensors;

the uniformly varying air gap is between 3 mm and 6 mm;

the sensors are operatively connected to one or more actuators and are pre-set to cause activation or de-activation of said actuators, depending upon angular positions detected;

the pole shoe (7) surface has a suitably varied profile to simulate variation of shaft angle between 0° and 360°.

### BRIEF DESCRIPTION OF THE ACCOMPANYING DRAWINGS

Having described the main features of the invention above, a more detailed and non-limiting description of some exemplary embodiments are given in the following paragraphs, with reference to the accompanying drawings.

FIG. 1a is a perspective view of a preferred embodiment of the angular position sensing device using a ring permanent magnet with varying surface profile.

FIG. 1b is a sectional view of the device shown in figure la showing only the magnet, the sensors and the mounting plate for the sensors.

FIG. 1c is another embodiment of the angular position sensing device which uses a standard permanent magnet and pole shoe with varying surface profile.

FIG. 1d is a sectional view of the device shown in FIG. 1c showing only the magnet, the sensors and the mounting plate for the sensors.

FIG. 1e is a view of the magnetic flux lines and their variation for the embodiment shown in FIG. 1c.

FIG. 2a is a graph showing how the voltage output varies with change in angular position of the shaft of the device designed to measure any angle from 0° to 360°.

FIG. 2b is a preferred embodiment of the pole shoe applied according to the present invention.

FIG. 2c is a cross-sectional view of the practical design of the angular sensing device shown in FIG. 1c.

FIG. 3a is a graph of output voltage of the sensors, against angular position in degrees (up to 50°) of the lever of a flap slat control lever, according to another preferred embodiment.

FIG. 3b is a perspective view of the pole shoe which is applied to obtain the results shown in FIG. 3a.

FIG. 4a is a graph of output voltage of the sensors, against angular position in degrees (up to 90°) of the lever of a flap slat control lever.

FIG. 4b is a perspective view of the pole shoe which is applied to obtain the results shown in FIG. 4a.

FIGS. 5a and 5b illustrate graphically, sensor output voltage against misalignment error between pole shoe and sensors, FIG. 5b being an enlarged view of the FIG. 5a.

FIG. 5c is a perspective view of a typical pole shoe which can be applied and specifically shows possible misalignment error between sensors and pole shoe, which is graphically shown in FIGS. 5a and 5b.

FIG. 6a is a graphical representation of sensor output voltages against angular position at varying air gaps between the pole shoe and the sensors.

FIG. 6b is a perspective view of a pole shoe which is suited to maintain an ideal air gap of 3 mm to 6 mm between the pole shoe and the sensors.

FIG. 7 is an exploded view of a flap slat lever arrangement of an aircraft according to another preferred embodiment where the angular position sensing device is applied.

FIG. 8 is another preferred embodiment of the application shown in FIG. 7.

FIG. 9a is a compact modular design of the device of the present invention for any general purpose angular measurements.

FIG. 9b is an exploded,view of the angular sensing device which is shown in FIG. 9a.

### DETAILED DESCRIPTION OF THE INVENTION

The following paragraphs describe some preferred embodiments of the present invention which are purely exemplary for the sake of understanding the present invention and non-limiting.

In the accompanying figures which describe some preferred embodiments, like reference numerals represent like features. Further, when it is referred to as “top”, “bottom”, “upward”, “downward”, “above” or “below”, “front” or “rear” and similar terms, this is strictly referring to an orientation with reference to the figures where the front portion is facing the viewer.

It is also clarified that some of the preferred embodiments hereinafter, describe the application of the angular sensing device in a flap slat control lever of an aircraft. This is just for the sake of understanding where the sensors determine the angular position of the lever. It should be understood by persons skilled in the art that the angular position sensing device can have other applications as well and all these fall within the scope of the present invention.

Furthermore, the magnetic surface has been defined hereinafter at places, as a magnet attached to a pole shoe having varying surface profile. The magnetic surface may be defined in other ways as well of course within the scope of the present invention which has to ensure that the profile of the magnetic surface is correctly designed with or without a pole shoe.

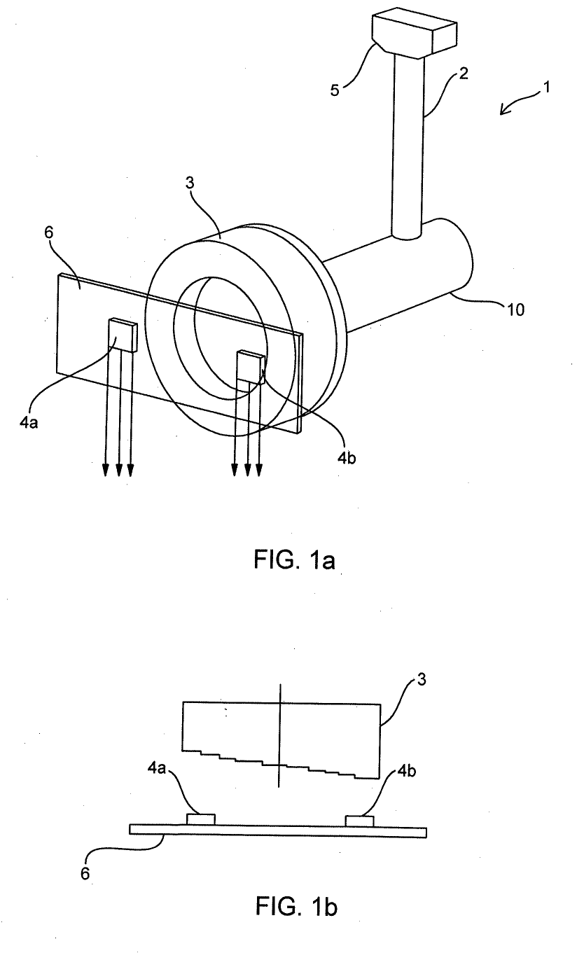

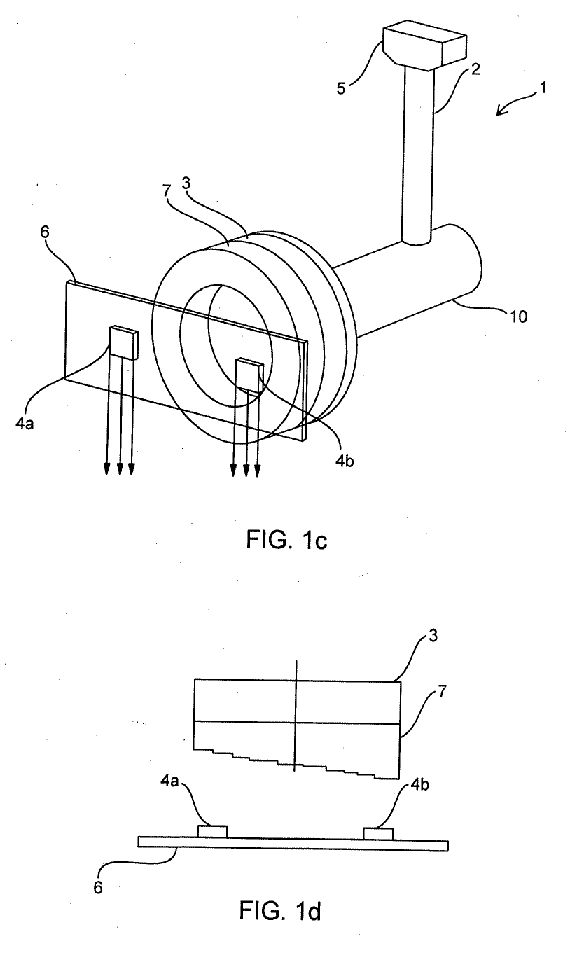

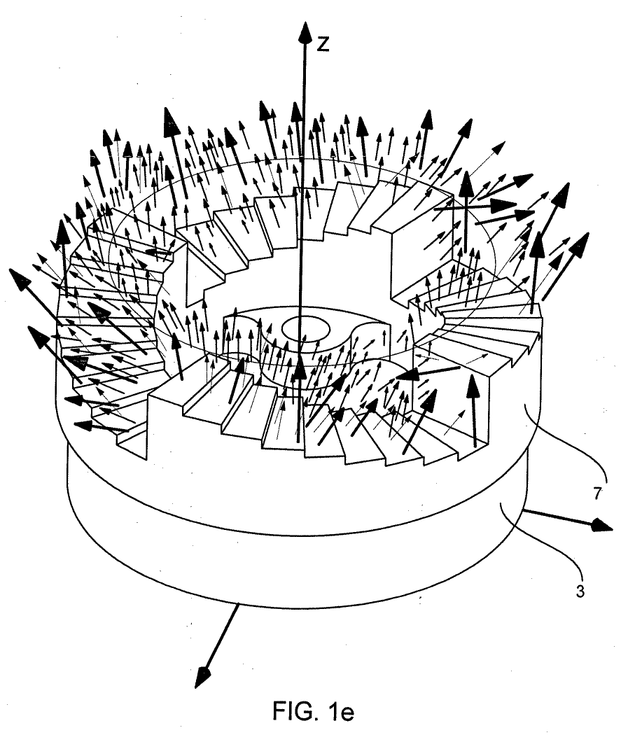

FIG. 1a is a perspective view of the basic structure of a preferred embodiment of the angular position sensing device (1). It has two sensors (4a and 4b), mounted on a plate (6). The sensors (4a and 4b) are located in front of a ring magnet (3) having axial magnetization. The ring magnet has varying surface profile on one side which is facing the sensors. The ring magnet (3) has a rotor shaft (10) which can rotate by means of a lever (2). The lever (2) has a gripping facility (5) to rotate the shaft (10) in the desired direction. It is within the scope of the present invention that this lever (2) may be replaced by any other suitable mechanism.

It would be clear from the basic structure shown in figure la that the sensors are Hall Effect sensors and these detect the angular position of the shaft (10). How this is done, has been explained later.

FIG. 1b is a cross sectional view of the device shown in FIG. 1a, showing the profile of the magnetic surface of the ring magnet (3) in detail. It should be clear from FIG. 1b that ring magnet (3) has varying surface profile on one side which is facing the sensors (4a,4b).

FIG. 1c is another embodiment of the angular position sensing device. It uses a standard permanent magnet (3) and pole shoe (7) with a varying surface profile on one side which is facing the sensors. Here, the magnetic surface with varying surface profile is defined by the standard permanent magnet (3) and pole shoe (7). FIG. 1d is the cross sectional view of the embodiment shown in FIG. 1c, which clearly shows this profile of the magnetic surface in detail.

When the shaft (10) is rotated, the air gap between the magnetic surface and the sensors (4a, 4b) varies uniformly in both cases as best shown in FIG. 1a and FIG. 1c.

FIG. 1e shows the magnetic flux lines and their variation for a typical design. When this FIG. 1e is construed together with FIGS. 1a and 1c it should be clear that the magnetic circuit is so designed that the field lines pass perpendicular to the sensors and hence generate maximum output. Application of a magnet of axial magnetization with symmetrical magnetic field further enhances this aspect.

The sensor output voltage is proportional to the magnetic flux which depends on the magnetic air gap between the sensor and the magnetic surface. This aspect would be further clear from the subsequent description.

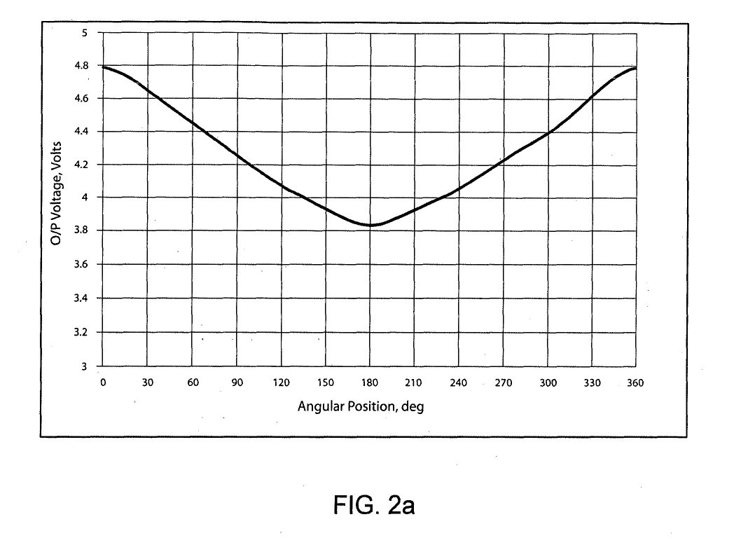

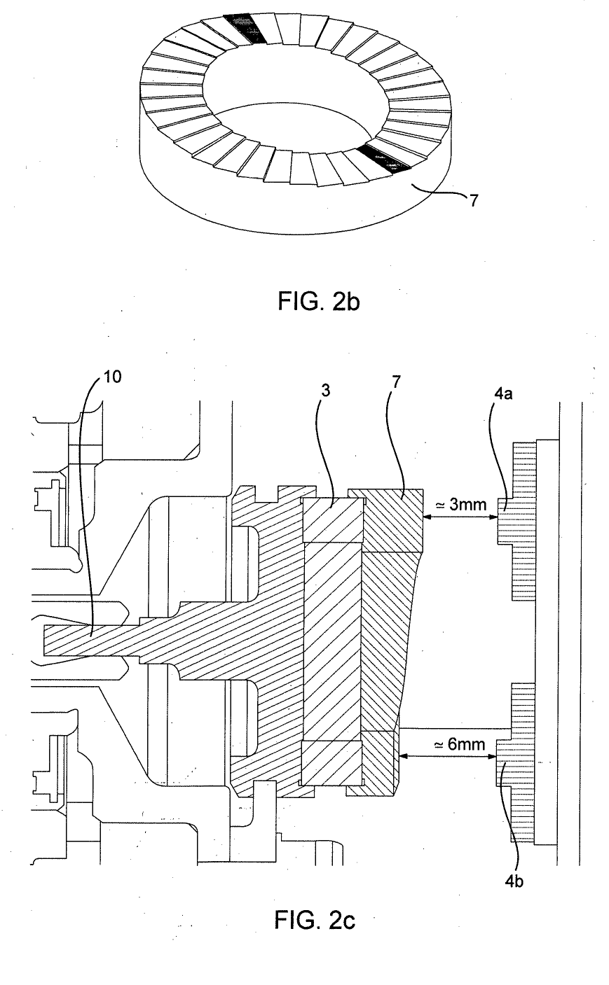

FIG. 2a is a graph with output voltage in the X-axis and the corresponding angular position in the Y-axis. The graph shows how the output voltage varies with changing angular position of the shaft (10). Between 0° to 180° the output voltage decreases and thereafter increases between 180° and 360°. Why this happens is known to persons skilled in the art and is not explained further. Reasonable explanation also exists in the portion “Background of the Invention”.

FIG. 2b is a perspective view of the pole shoe (7) that is applied in the present invention.

The role of this pole shoe (7) would be clear from the sectional view in FIG. 2c. It shows that the pole shoe (7) with the magnet (3) can be rotated by the shaft (10). The pole shoe (7) has a varying surface profile such that the air gap while rotation varies between 3 mm and 6 mm. This varying air gap simulates angular position change of the shaft (10) and a possible lever (2), actuating the shaft (10).

The varying air gap in fact triggers varying magnetic field and consequentially, varying output voltages of the sensors (4a, 4b). On doing appropriate calibration of the sensor output with respect to the shaft angle, the angular position of the shaft (10) and hence the lever (2) actuating it can be deciphered. The sensor output is a direct measure of the shaft position. The air gap simulates angular position change of the shaft (10).

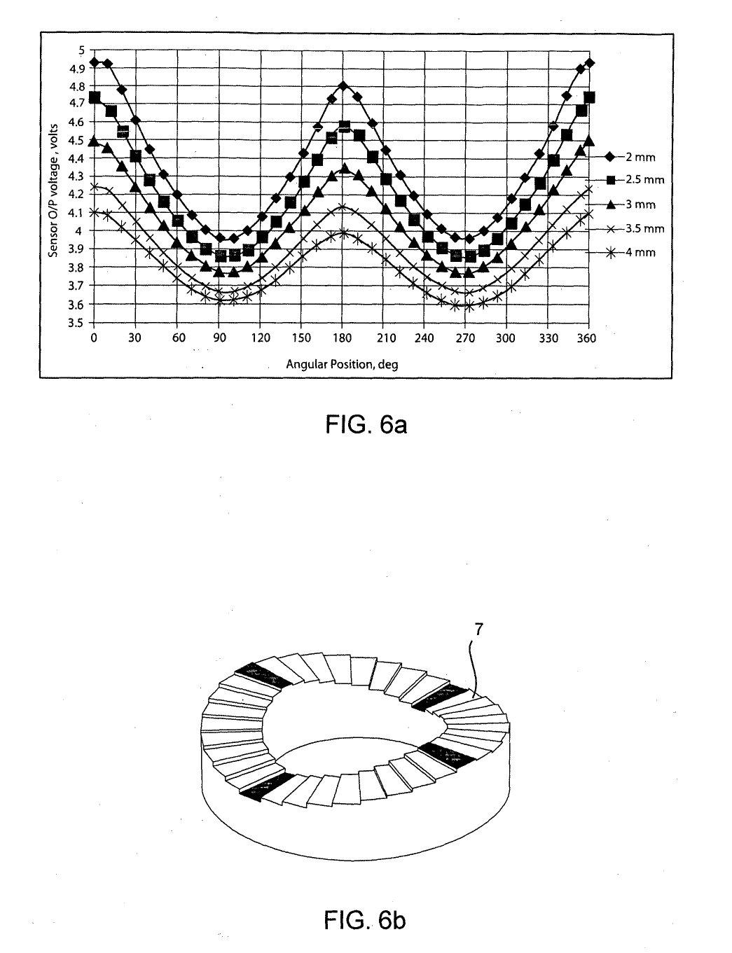

Referring to FIG. 2b, the surface profile of the pole shoe (7) plays a vital role in determining the angular position of the shaft (10). It is so profiled that on rotation with the magnet (3) the magnetic field varies uniformly due to uniformly varying air gap between the sensors (4a, 4b) and the pole shoe (7). The uniform air gap variation is arrived at by shaping various pole shoes and plotting the output voltages against air gaps. This has been further explained later with reference to FIG. 6a.

Thus the inclined surface of the pole shoe (7) helps to achieve uniform variation in magnetic field and consequential output voltages, so that the sensor output voltages can be calibrated with respect to shaft position. Thus, the sensor voltage variation reflects shaft angle variation.

The shape of the pole shoe (7) is thus the crux of the present invention in as much as it helps to achieve the principal objective and other objectives of the present invention. The shape of the pole shoe (7) is heavily dictated by the function it performs.

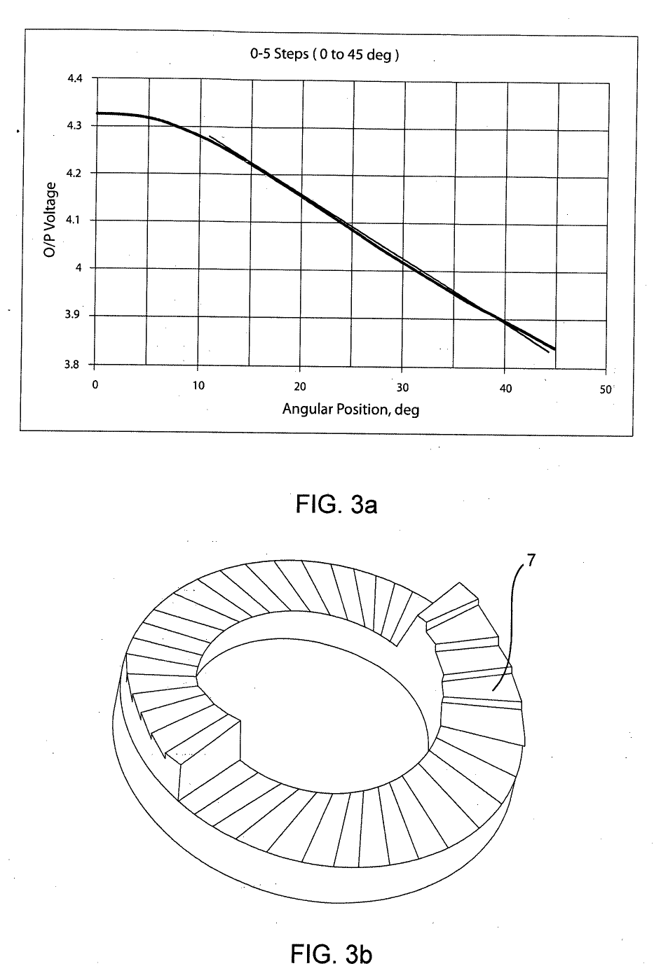

Referring to FIG. 3b first, here the pole shoe (7) is modified in tune with a smaller angular variation of an object, say a flap and slat control lever (hereinafter referred to as FSCL for the sake of brevity) of an aircraft. The angular variation in position of the FSCL considered here is 0° to 50°. The air gap variation achieved by the pole shoe (7) in this case simulates an operating angular range of 0° to 50° for the FSCL.

FIG. 3a is a graph showing the output voltages against angular position of the FSCL, when the profile of the pole shoe (7) is as shown in FIG. 3b.

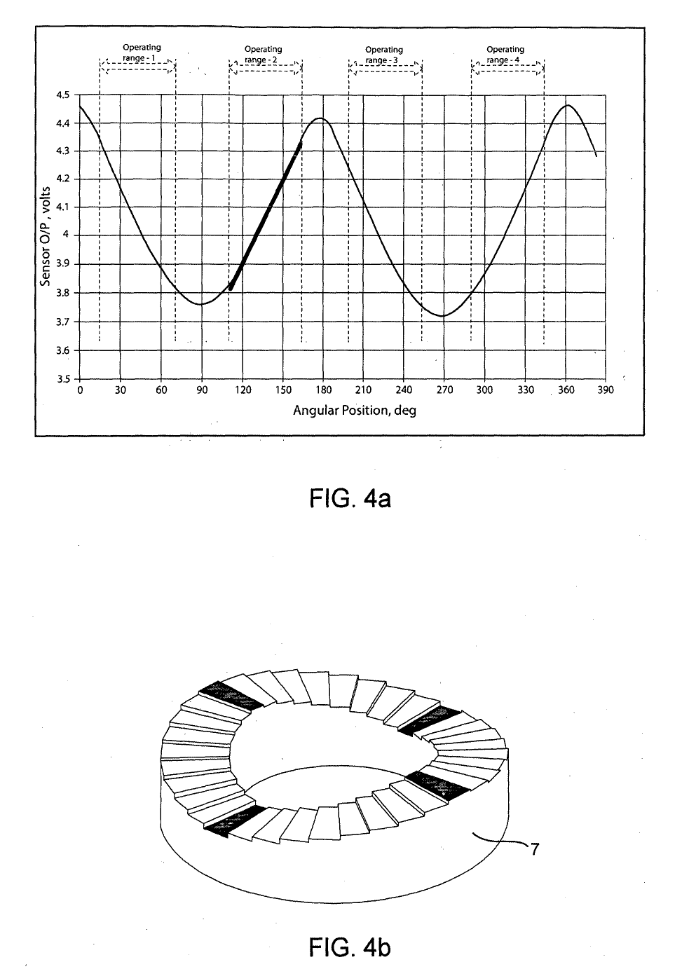

FIG. 4b is a perspective view of a pole shoe (7) modified to simulate an angular variation of the FSCL between 0° and 90°. FIG. 4a is the corresponding graph.

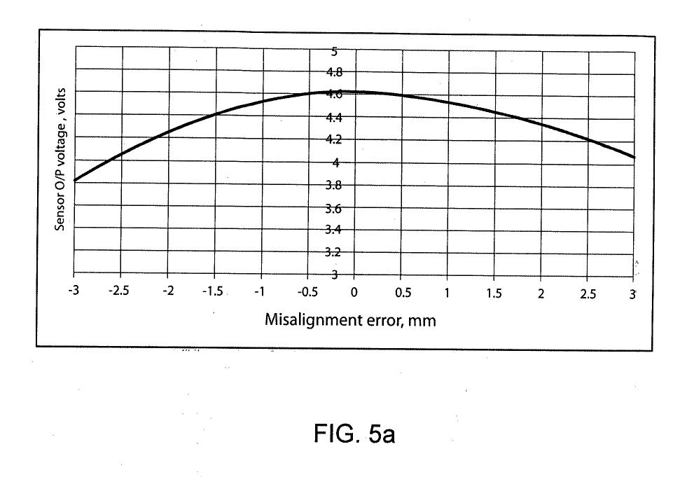

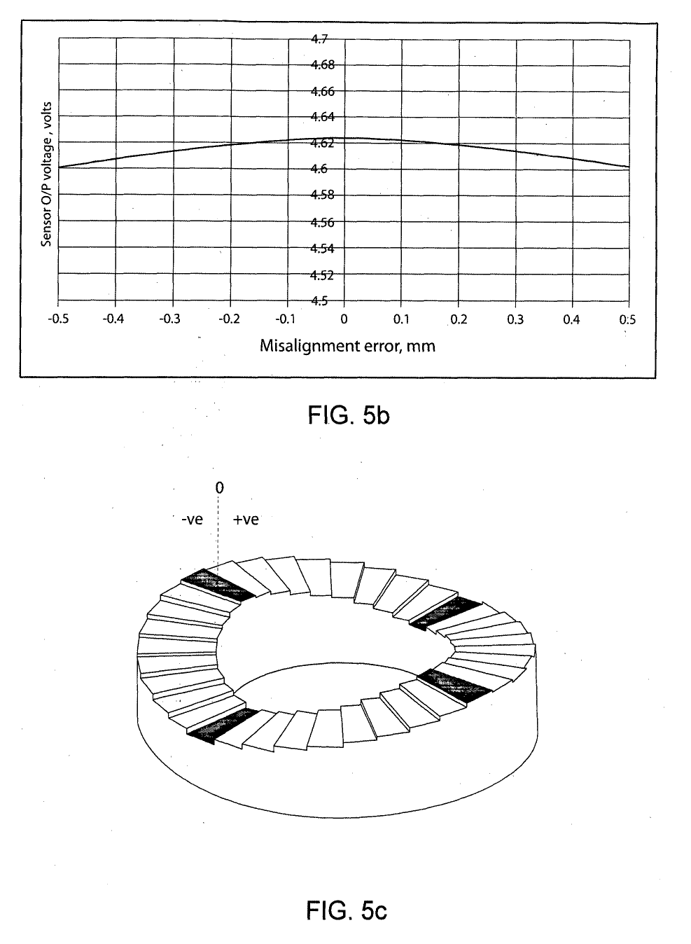

It should be understood from the graphs in FIGS. 4a and 5a that the sensor outputs are linear within 5% and can be improved by proper machining and this is within the scope of the present invention.

FIGS. 5a and 5b illustrate graphically, sensor output voltage against misalignment error between pole shoe and sensors, FIG. 5b being an enlarged view of the FIG. 5a.

FIG. 5c is a perspective view of a typical pole shoe which can be applied and specifically shows possible misalignment error between sensors and pole shoe, which is graphically shown in FIGS. 5a and 5b.

It would be clear on construing FIGS. 5a, 5b and 5c together that the misalignment is within the acceptable limits of ±0.5 mm.

FIG. 6a is very important so far as the crux of the present invention is concerned. It exactly shows how the correct profile of the pole shoe (7) is arrived at. Plotting of sensor outputs against angular position of the object is done at varying minimum air gaps, i.e. for varying surface profiles of the pole shoe (7).

On comparison of the plots it would be clear that optimal air gap is 3 mm for the chosen size and configuration of the device. The corresponding pole shoe profile is shown in FIG. 6b.

Just in the same manner as in FIG. 6a, the maximum optimal air gap is deciphered. The value has been found to be approximately 6 mm. The corresponding profile of the pole shoe is as in FIG. 6b, having an inclined surface varying between 2 mm and 5 mm in height.

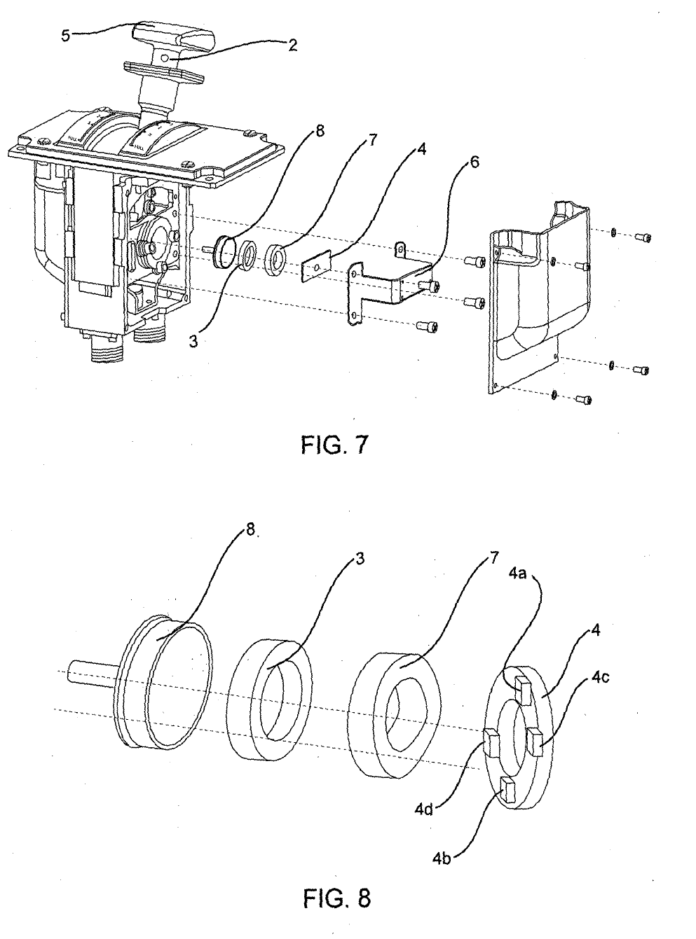

FIG. 7 is an FSCL application of the device. This has been partially discussed with reference to FIGS. 3a, 3b, 4a and 4b. FIG. 7 is the exploded view. It shows the FSCL (2) with a gripping arrangement (5). Rest of the features and functioning are same as explained with reference to the basic structure shown in FIGS. 1a and 2c. This figure also shows the adaptor (8).

The basic principle of functioning is naturally the same. To be precise the design of the pole shoe (7) ensures an air gap variation between the sensors and the pole shoe (7). Thus, magnetic field variation and corresponding sensor output variation is achieved. The latter is calibrated with respect to the lever (2) position. Hence, angular variation in lever (2) position is effectively simulated by correctly designed air gap variation.

The sensors (4a, 4b) are operatively connected to actuators which are located along the wings of the aircraft. Depending upon the position of the FSCL detected, the sensors activate or deactivate the actuators for extension or retraction of the flaps and slats as and when required, say during take-off or during landing of the air craft.

The angular variation that can be simulated can be between 0° and 90° as explained with reference to FIGS. 3a, 3b, 4a and 4b and are not explained again to avoid repetition.

FIG. 8 is an exploded view of another preferred embodiment.

All features are same here excepting the sensor features. This design can be used to obtain four position-sensing outputs simultaneously with the same hardware by simply adding four Hall Effect sensors.

Here, the sensor unit (4) comprises four Hall sensors (4a, 4b, 4c and 4d) on a single PCB. This can be utilized by the FSCL effectively with four position sensing outputs simultaneously, with same hardware. Redundancy can be fully achieved in this scheme. The additional sensors are used for redundancy or to obtain multi-channel outputs.

The output voltage of two sensors is with positive slope while that of the other two is of negative slope. It should be understood that simple electronics can be used to reverse the negative slope to a positive slope and this is within the scope of the present invention.

As an alternative, the FSCL can have two sensor units, each comprising two sensors on a PCB and this is also within the scope of the present invention.

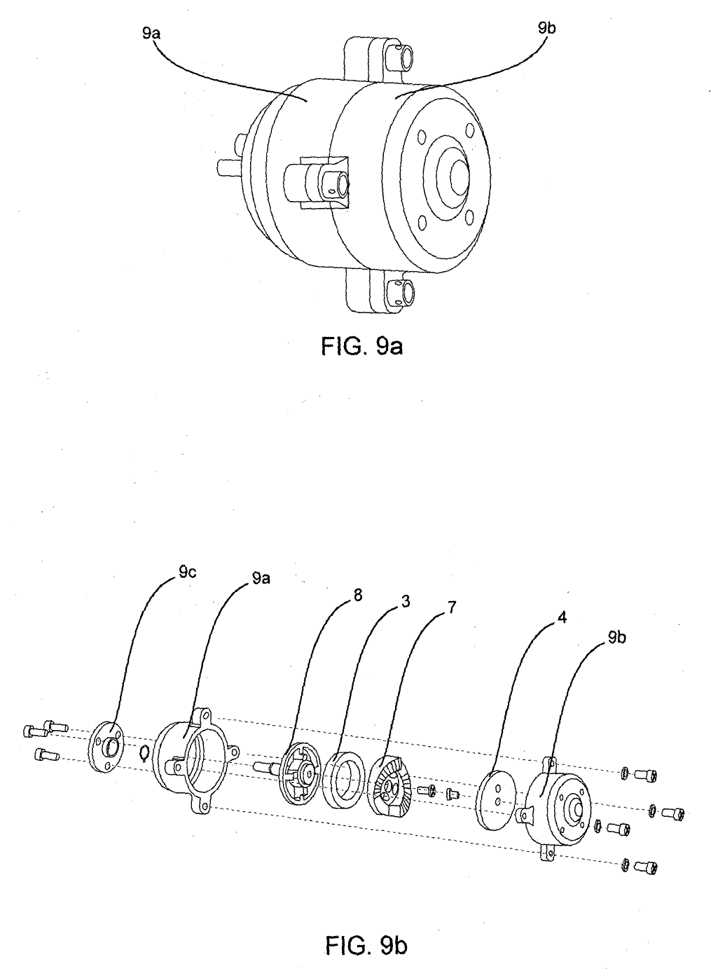

FIG. 9a is a compact modular design for the angular position sensing in accordance with another preferred embodiment. The construction of this embodiment would be clear from FIG. 9b.

FIG. 9b is an exploded view of FIG. 9a. The angular position device is constructed using the concept shown in FIGS. 1a, 1c, 2b and 2c and all the figures should be construed together. Apart from what is shown in FIGS. 1a,1c,2a and 2c, this figure shows the housing (9a) for the sensor unit (4) mounted on a PCB, the end plate (9c) for the housing, the adaptor (8) and also the housing cap (9b). The sensor unit (4) has at least two sensors (4a, 4b) as explained before.

It would be clear from the description hereinbefore that the objectives of the present invention are met. The device is light weight, simple, low cost and yet technically effective. It would be clear from the functioning that the angular position is detected with precision, due to the simple technical principle on which the device works and chances of error are substantially low.

In addition to the above, it would be clear from the description hereinbefore and the appended claims that the present invention uses less expensive magnet assembly and the magnetic circuit is so designed that the field lines pass perpendicular to the sensors and hence generate maximum output. Application of a magnet of axial magnetization with symmetrical magnetic field further enhances this aspect. All these features coherently ensure detection of angular position of the desired object with precision and also in a cost effective manner.

The present invention has been described with reference to some preferred embodiments and some drawings for the sake of understanding and not by way of any limitation and it is to be understood that the present invention includes all legitimate developments within the scope of what has been described hereinbefore and claimed in the appended claims.

1. An angular position sensing device comprising Hall Effect sensors mounted in front of at least one rotatable magnet and the output voltage of the sensors varies with changing position of the magnet characterized in that the magnet is suitably mounted and the magnetic surface has a varying surface profile such that in the event of rotation of the magnet, a uniformly varying air gap is formed between the sensors and the magnetic surface, thus creating an uniformly varying magnetic field.

2. The device as claimed in claim 1 wherein the profile is variable depending upon the angular position range to be detected.

3. The device as claimed in claim 1 wherein the magnet is a ring magnet with said varying surface profile being located at the side facing the sensors and the ring magnet is rotatably mounted to a shaft operable by means of a lever.

4. The device as claimed in claim 1 wherein the magnetic surface comprises a standard ring magnet attached to a pole shoe, the latter having a surface profile such that, in the event of rotation of the magnet and the pole shoe, an uniform air gap between the pole shoe and the sensors is created.

5. The device as claimed in claim 4 wherein the magnet and the pole shoe are rotatably attached to a shaft operable by means of a lever.

6. The device as claimed in claim 4 wherein at least two sensors are mounted on a housing of the device using a mounting plate such that, the sensors are located in front of the pole shoe and its said surface profile is at the side facing the sensors.

7. The device as claimed in claim 4 wherein the pole shoe surface profile is such that the air gap varies to simulate the angular position of the shaft whereby the voltage outputs given by the sensors enable detection of angular position of the shaft.

8. The device as claimed in claim 1 wherein the uniformly varying air gap is between 3 mm and 6 mm.

9. The device as claimed in claim 1 wherein the sensors are operatively connected to one or more actuators and are pre-set to cause activation or de-activation of said actuators, depending upon angular positions detected.

10. The device as claimed in claim 7 wherein the pole shoe surface has a suitably varied profile to simulate variation of shaft angle between 0° and 360°.

11. A flap slat control lever for an air craft incorporating the angular sensing device as claimed in claim 1 wherein there are four Hall sensors mounted on a single PCB for sensing the angular position of the lever and accordingly causing retraction or extension of flaps/slats.

12. A flap slat control lever for an air craft incorporating the angular sensing device as claimed in claim 1 wherein there are two sensor units each having two sensors mounted on a PCB for sensing the angular position of the lever and accordingly causing retraction or extension of flaps/slats.
